(19) United States
(12) Patent Application Publication
(10) Pub. No.: US 2011/0310406 A1
(43) Pub. Date: Dec. 22, 2011

(54) BITMAP ANALYSIS

(75) Inventors: Albert Serra Monner, Terrassa (ES); Peter Morovic, Sant Cugat del Valles, Barcelona (ES)

(73) Assignee: HEWLETT-PACKARD DEVELOPMENT COMPANY, L.P., Houston, TX (US)

(21) Appl. No.: 12/817,770

(22) Filed: Jun. 17, 2010

(51) Int. Cl. H04N 1/60

(52) U.S. Cl. 358/1.9

(57) ABSTRACT

A method for bitmap analysis for print cost estimation performed by a physical computing system includes, with the physical computing system, receiving an electronic document comprising an image to be printed; with the physical computing system, analyzing a bitmap format of the image; and with the physical computing system, using an analysis of the bitmap format of the image to determine an estimate of an amount of ink to be used to print the image.

### BACKGROUND

Various business entities provide print services for large scale printing onto banners and other signage items. When providing such services, it is often difficult to determine the cost of printing a particular image before actually printing the image. The cost of printing an image is dependent upon several factors including the size of the image to be printed, the type of print medium to be used, and the amount of ink needed for the print job. Although the cost factors of image size and print medium may be easy to determine, the amount of ink which will be consumed to print a particular image is difficult to determine without actually printing the image.

In order to accurately determine the amount of ink required to print a particular image, the whole imaging pipeline is simulated. The imaging pipeline refers to the process of getting an electronically stored image ready for print. This process may include, but is not limited to, converting the source image to a destination color space, applying separation look-up tables, linearizing the image and half-toning the image. This process is quite processor intensive, especially for larger images designed for large signage items such as billboards and banners. Thus, it may take quite awhile for a customer to receive an accurate quote for printing a particular image. Additionally, this process is dependent on the printing device and its color settings used to print the image. If a business entity provides a print cost quote for a specific printing device, the business entity is generally limited to performing the print job with the specific printing device specific color settings used in the quoting process to ensure that the print cost quote remains accurate. This may be problematic if that specific printing device is backlogged or inoperable for some reason.

### BRIEF DESCRIPTION OF THE DRAWINGS

The accompanying drawings illustrate various examples of the principles described herein and are a part of the specification. The illustrated figures are merely examples and do not limit the scope of the claims.

FIG. 1 is a diagram showing an illustrative computing system, according to one example of principles described herein.

FIG. 2A is a diagram showing an illustrative pixel, according to one example of principles described herein.

FIG. 2B is a diagram showing illustrative pixel data, according to one example of principles described herein.

FIG. 3 is a diagram showing an illustrative pixilated image, according to one example of principles described herein.

FIG. 4 is a diagram showing an illustrative ink usage categorization process, according to one example of principles described herein.

FIG. 5 is a diagram showing an illustrative table of print jobs, according to one example of principles described herein.

FIG. 6 is a flowchart showing an illustrative method for bitmap analysis for a print cost quote, according to one example of principles described herein.

Throughout the drawings, identical reference numbers designate similar, but not necessarily identical, elements.

### DETAILED DESCRIPTION

As mentioned above, the cost of printing an image is dependent upon several factors including the size of the image to be printed, the type of print medium to be used, and the amount of ink which will be consumed during the print job. Although the cost factors of image size and print medium may be easy to determine, the amount of ink which will be consumed to print a particular image is difficult to determine in advance.

In order to accurately determine the amount of ink required to print a particular image, the whole imaging pipeline is simulated. The imaging pipeline refers to the process of getting an electronically stored image ready for print. This process may include, but is not limited to, converting the source image to a destination color space, applying separation look-up tables, linearizing the image and half-toning the image. This process is quite processor intensive, especially for the printing of larger images. Furthermore, this process is dependent upon the printing device and its color settings which will be used to print the image.

In light of this and other issues, the present specification discloses a method for performing a bitmap analysis on an image to be printed. Based on the analysis of the bitmap formatted image, the image is placed in an ink usage category. A print cost quote can then be readily provided based on the ink usage category to which an image belongs.

According to certain illustrative examples, an ink usage categorization system receives an electronic document which includes an image to be printed. To estimate the ink usage which would be needed to print the image, the ink usage categorization system rasterizes the image if it is not already in a bitmap format. With the image in a bitmap format, the ink usage categorization system can analyze the bit values representing the color for each pixel of the image.

There is a correlation between the bit value used to represent a color and the amount of ink required to print that color. For example, a bit value is indicative of the intensity of a color. Lighter colors do not require as much ink as darker colors. As certain bit value ranges correspond to lighter colors and some bit value ranges correspond to darker colors, the bit values can be used to estimate the amount of ink required to print the image.

Through use of a system embodying principles described herein, an ink usage categorization system can readily provide a customer with a print cost quote without having to run the electronic document that includes the image to be printed through the entire print imaging pipeline or a simulation of that pipeline. Additionally, the print cost estimation technique described herein is device independent. Thus, the business entity which will be printing the image may use any practical printing device to print the image without incurring costs far outside the quoted print cost.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

Throughout the specification and in the appended claims, the term “image” is to be broadly interpreted to include graphics, text, and other elements which may be represented electronically and printed onto a print medium.

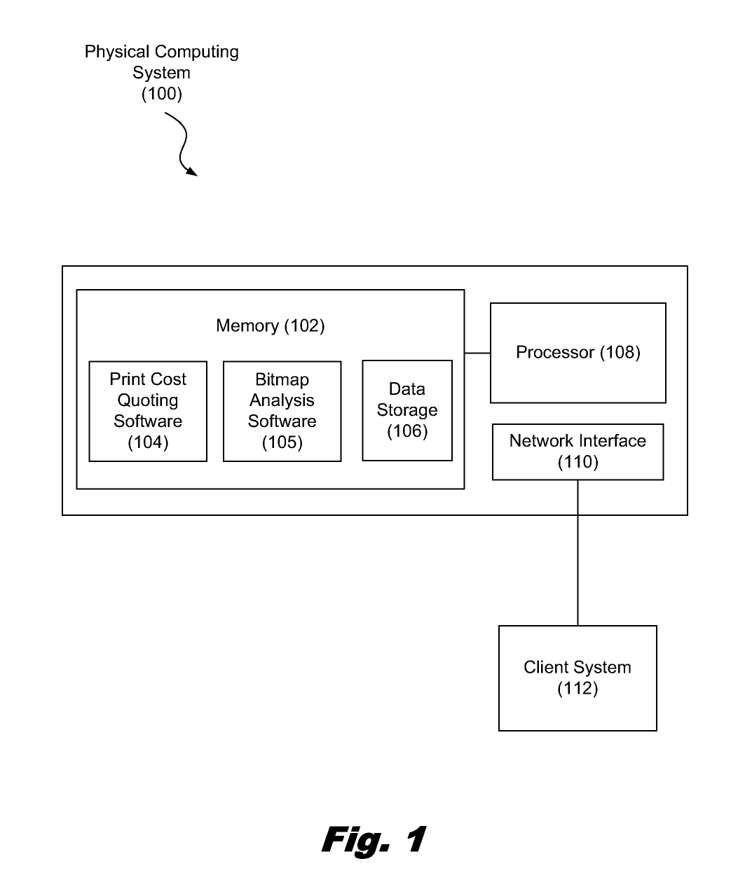

Referring now to the figures, FIG. 1 is a diagram showing an illustrative physical computing system (100) which may be used to perform a bitmap analysis on an image to estimate the amount of ink needed to print the image. According to certain illustrative examples, the physical computing system (100) may include a memory (102) having software (e.g., 104, 105) and data (106) stored thereon. As described below, this software can include bitmap analysis software (105) and print cost quote software (104).

With regard to the memory unit (102), there are many types of memory available. Some types of memory, such as hard disk drives, optical disc drives, and solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104, 105) and data (106).

The physical computing system (100) also includes a processor (108) for executing the software (104, 105) and using or updating the data (106) in the memory (102). The physical computing system (100) may be embodied as a variety of physical computing devices including, but not limited to, a laptop or tablet computer, a desktop computer, and a Personal Digital Assistant (PDA) or mobile smart phone.

Various types of software (104, 105) may be utilized by the physical computing system (100). For example, one type of software which may be stored in memory is print cost quoting software (104). The print cost quoting software is a program designed to provide a customer with a fast print cost quote for printing an image. This is done by using bitmap analysis software (105) to analyze the bitmap format of the image. The bitmap analysis software (105) analyzes the bit values representing the colors of the pixels within the image. With this analysis, the bitmap analysis software (105) can estimate the ink usage needed to print the image and place the image into an ink usage category. The print cost quote software (104) can then provide a print cost quote based on the ink usage category to which the image belongs.

The physical computing system (100) includes a network interface (110). The network interface (110) allows the physical computing system to communicate with other computing systems such as a client system (112). The network interface (110) may employ a variety of methods to communicate with other computing systems including, but not limited to, ethernet connections, wireless connections, and fiber optic connections. The network interface (110) may be used to send and receive communications from the client system (112). For example, a client system (112) can send a print cost quote request to the physical computing system (100). The physical computing system (100) receives this request through the network interface (110). After processing the request, the physical computing system (100) can send a completed print cost quote to the client system (112) through the network interface (110).

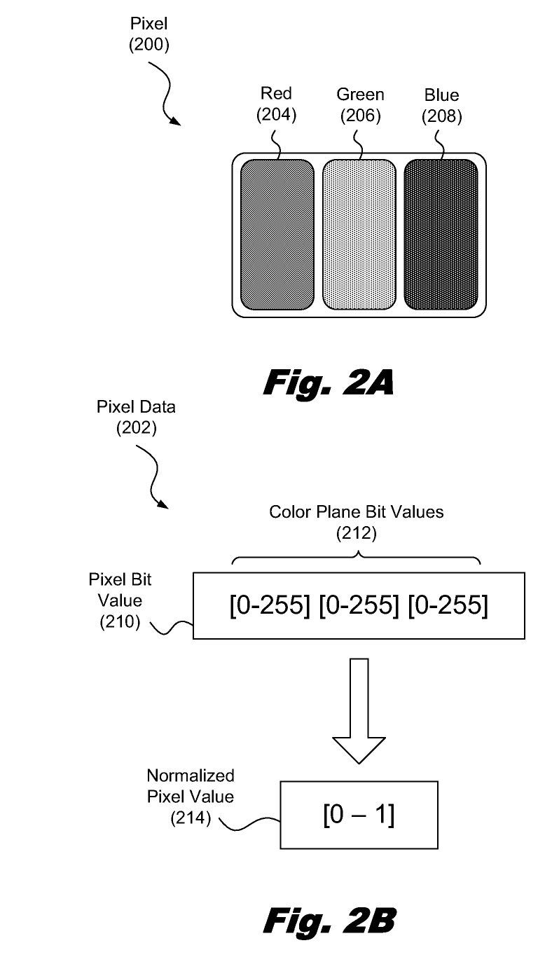

FIG. 2 is a diagram showing an illustrative method of pixel representation (200). A pixel (202) is the smallest controllable unit of a digital or electronically stored image. The color displayed by a particular pixel (202) may be formed by manipulating the intensity of three different color planes. In one commonly used color scheme, the three different color planes are red (204), green (206), and blue (208). With this Red, Green, and Blue (RGB) color scheme, a standard color gamut can be created.

The RGB color scheme is often referred to as an additive color scheme. This is because the colors red, green, and blue are “added” to a normally black background. A black background is generally present on television screens and computer monitors. Thus, the RGB color scheme is typically used to display images on such devices. When displaying images on such devices, the color black is produced by having no intensity from any of the three color planes. Conversely, the color white is produced by having full intensity of all three color planes. Variation between no intensity and full intensity by some or all of the three color planes produces a standard color gamut.

When printing images onto a white print medium, a subtractive color scheme is be used. One commonly used subtractive color scheme is the Cyan, Magenta, and Yellow (CMY) color scheme. The CMY scheme is a complimentary scheme to the RGB color scheme. Particularly, cyan is the complimentary color of red, magenta is the complimentary color of green, and yellow is the complimentary color of blue. In such a color scheme, to produce a white color, no intensity is used for any of the three color planes. Conversely, the color black is produced by having full intensity of each of the three color planes.

When using the CMY scheme, the intensity for all three color planes for a particular pixel has an effect on the amount of ink required to produce the color for that pixel onto the print medium. As the RGB scheme has an inverse relationship to the CMY color scheme, an analysis of the data representing an image with the RGB color scheme can be used to determine an ink usage estimate for printing the image.

The use of RGB and CMY color schemes is merely one example of color schemes embodying principles herein. Other color schemes such as Specifications for Web Offset Publications (SWOP) may be used as well.

FIG. 2B is a diagram showing how pixel data (202) may represent a pixel. According to certain illustrative examples, a pixel may be represented by three 8-bit color plane bit values (212). The total group of bits may be referred to as a pixel bit value (210). As will be appreciated by one skilled in the art, 8 bits allows a discrete set of values ranging from 0-255. Thus, 256 different degrees of color intensity for each color plane may be used to represent over 16 million different colors. In some cases, more bits may be used to represent each color plane within a pixel. Doing so allows for finer color precision but consumes more memory. Conversely, fewer bits may be used to represent each color plane within a pixel. Doing so consumes less memory but produces a narrower color gamut range.

According to one illustrative example, to estimate the ink usage of a pixel, the sum of the color plane bit values (212) of the pixel bit value (210) for that pixel is determined. Using the 8 bit example, this sum will range from 0-765. A value of 765 indicates that all the colors of the RGB scheme are at full intensity, producing a white color. Thus, a value of 765 indicates that no ink is needed to print this pixel because the print medium is already white. In general, the higher the sum of the color bit values for a particular pixel, the less ink will be used to print the pixel onto the print medium. Conversely, the lower the sum of the color bit values for a particular pixel, the more ink will be used to print that pixel onto the print medium

As will be appreciated by those skilled in the relevant art, a particular pixel does not necessarily correspond to one ink droplet. Several small ink droplets may be used to produce a particular pixel on a print medium. Conversely, one ink droplet may be used to produce an average color of several pixels onto the print medium.

In some cases, the sum of each of the three color plane bit values may be normalized. The normalized pixel bit value (214) can be a decimal value ranging between zero and one. Depending on the convention, a normalized pixel bit value approaching zero may indicate little ink usage and a normalized pixel bit value approaching one may indicate greater ink usage or vice versa.

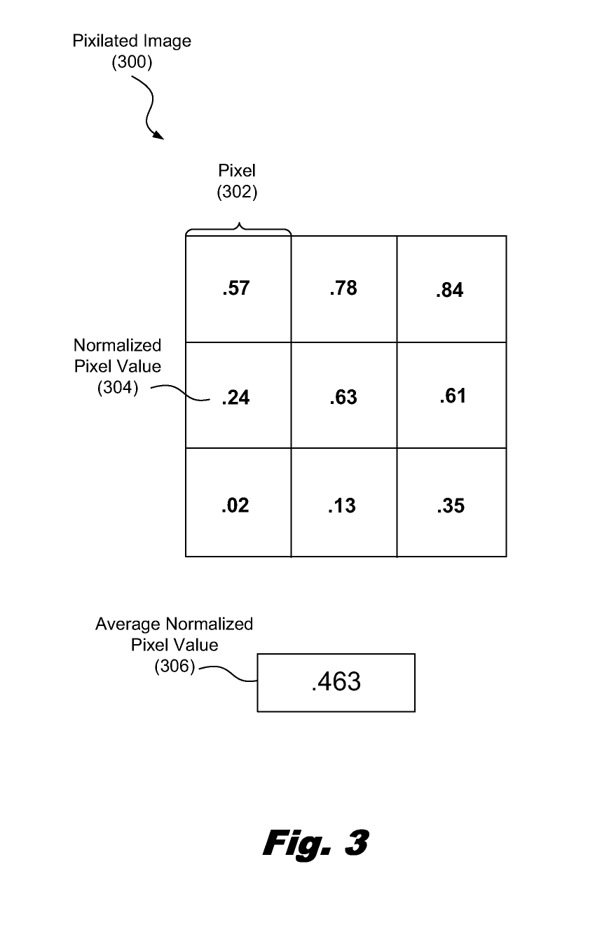

FIG. 3 is a diagram showing an illustrative pixilated image (300). A pixilated image (300) is an image which is represented by a number of pixels (302). The example shown in FIG. 3 is an image which is three pixels (302) wide and three pixels (302) tall. As will be apparent to those skilled in the art, a total of 9 pixels (302) is too small to represent a practical image. The example of FIG. 3 is for illustrative purposes only. A practical pixilated image would have a much larger number of pixels (302). For example, a practical pixilated image may be 1000 pixels wide and 800 pixels tall.

By analyzing the bitmap format of an image based on the principles described above, a normalized pixel bit value (304) may be determined for each pixel within the image. An average normalized pixel bit value (306) may then be determined. The average normalized pixel bit value can then be used to estimate the ink usage required to print the pixilated image (300).

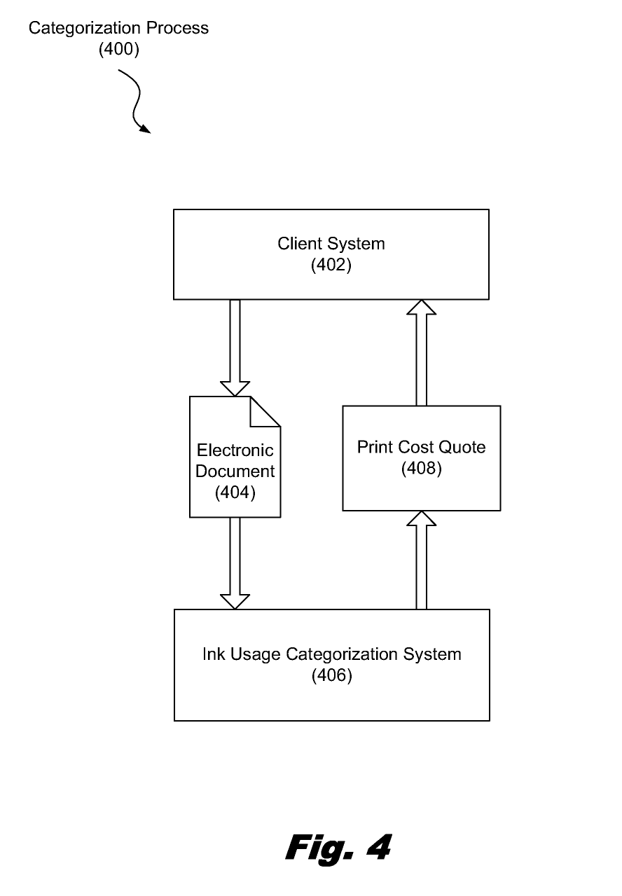

FIG. 4 is a diagram showing an illustrative ink categorization process (400). According to certain illustrative examples, the ink categorization process (400) starts when a client system (402) sends an electronic document (404) to the ink usage categorization system (406). The ink usage categorization system (406) then determines a print cost quote (408) and sends that quote (408) back to the client system (402).

The client system (402) may be any physical computing device including, but not limited to, a desktop workstation, a laptop computer, and a Personal Digital Assistant (PDA). In some cases, the client system (402) may be used to create and design the image to be sent to the ink usage categorization system (406) for a print cost quote (408). For example, a user may use graphic editing software to design an image to be printed on a billboard or banner.

The user may then desire to receive a print cost quote for printing the design. The user may then use the client system (402) to put the design into an appropriate format and submit it to the ink usage categorization system (406). In some cases, the image to be printed may be created by a separate physical computing system and transferred to the client system (402). From there, the image may be sent as an electronic document (404) to the ink usage categorization system (406).

The electronic document (404) submitted from the client system (402) to the ink usage categorization system (406) may be placed in any format which the ink usage categorization system (406) is able to receive. For example, the ink usage categorization system (406) may request that users send documents in a specific format including, but not limited to Portable Document Format (PDF), Joint Photographs Expert Group (JPEG), and bitmap format.

To perform the bitmap analysis, the electronic document (404) is translated from whatever format it is received into a bitmap format. For example, some image formats use vector graphics. An image represented by vector graphics does not use a bit value for each pixel. Rather, vector graphics define objects and their properties to create an image. For example, to represent a line, the vector graphic image would include data indicating a start point, end point, thickness and color for that line. As the ink usage categorization system (406) works by analyzing the bit values for each pixel, the ink usage categorization system (406) will first translate the received image into a bitmap format, if it is not already in a bitmap format. The process of transferring an image file into a bitmap format is referred to as rasterizing.

In some embodiments, the resolution of the bitmap image may be scaled to a predetermined resolution. For example, the analysis of the bitmap formatted image may be designed to work with a specific resolution. Therefore, any image to be analyzed can be scaled to that resolution.

As mentioned above, it is a processor intensive and time consuming process to simulate the imaging pipeline in order to determine an accurate level of ink usage for a particular image. Thus, the ink usage categorization system (406) may simply analyze the rasterized image to estimate the ink usage in a manner as described above. Particularly, the ink usage categorization system (406) can use the bit values used to represent each pixel to estimate an ink usage.

After analyzing the bit values of the pixels within the image, the ink usage categorization system (406) can estimate the amount of ink needed to print the image. With that estimate, the ink usage categorization system (406) places the image of the electronic document (404) into an ink usage category. Based on the ink usage category, the ink usage categorization system (406) can then provide a quote to the user requesting the print quote. The business entity managing the ink usage categorization system (406) can associate a print cost quote with an ink usage category as desired.

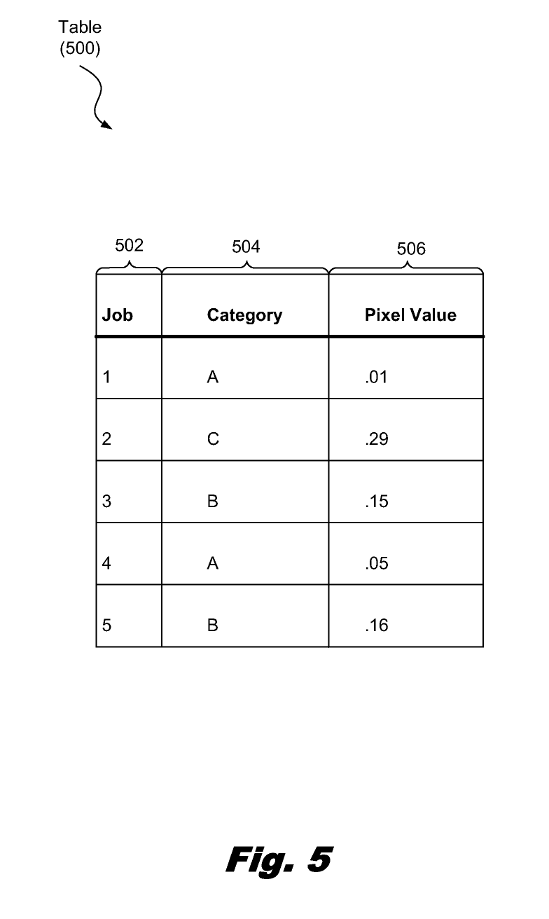

FIG. 5 is a diagram showing an illustrative table (500) of print jobs. According to certain illustrative examples, a print cost quote may be determined by an ink usage category (504). An image to be printed may be placed into a particular category based on the analysis of the bit values representing each of its pixels. The table (500) of FIG. 4 includes a job column (502), a category column (504), and a pixel bit value column (506).

The job column (502) lists five different job numbers. The category column (504) indicates which ink usage category those jobs have been placed. The ink usage category is determined based on the analysis of the bit values used to represent the image for the job. The pixel bit value column (506) displays normalized average values for the case that the ink usage categorization system uses such means to display the analysis of the bit values used to represent an image. For example, an average normalized pixel bit value ranging from 0.00-0.08 may be placed into category A; an average normalized pixel bit value ranging from 0.09-0.18 may be placed into category B; and an average normalized pixel bit value ranging from 0.19-0.32 may be placed into category C.

Referring again to FIG. 4, the ink usage categorization system (406) may provide a print cost quote based on the category assigned to an image alone. In other cases, the ink usage categorization system (406) may provide a print cost quote based on a calculation using the actual average pixel bit value. The ink usage categorization system (406) can also factor other aspects of a print job into the print cost quote. For example, the ink usage categorization system (406) may use the size and print medium type to calculate a print cost quote.

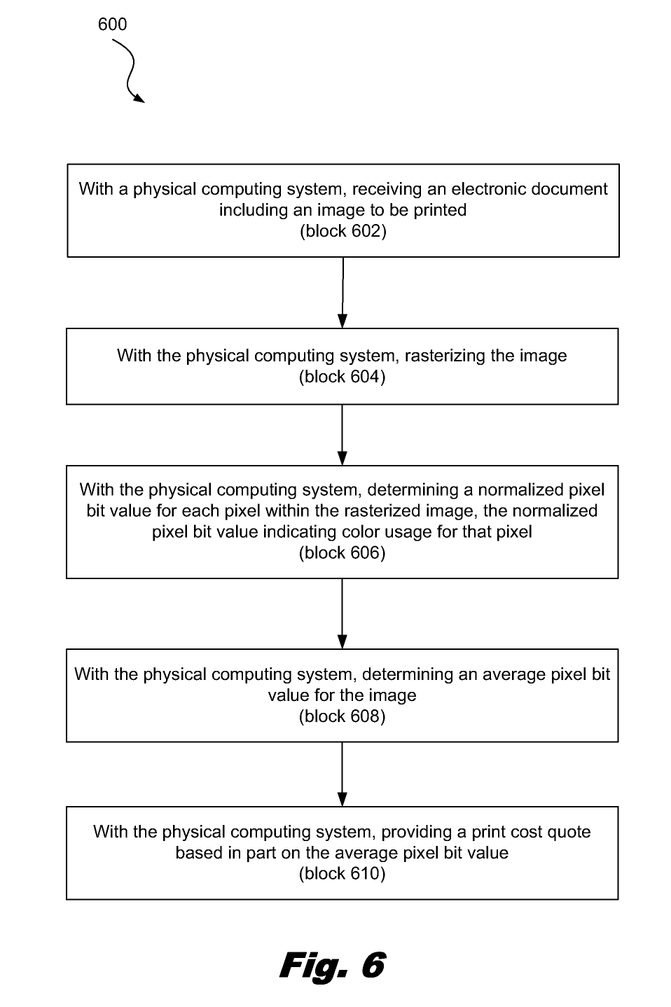

FIG. 6 is a flowchart showing an illustrative method (600) for bitmap analysis for a print cost quote. According to certain illustrative examples, the method (600) may include, with said physical computing system, receiving (block 602) an electronic document comprising an image to be printed; with said physical computing system, rasterizing (block 604) said image; with said physical computing system, determining (block 606) a normalized pixel bit value for each pixel within said rasterized image, said normalized pixel bit value indicating color usage for that pixel; with said physical computing system, determining (block 608) an average normalized pixel bit value for said image; and with said physical computing system, providing (block 610) a print cost quote based in part on said average pixel bit value.

In sum, through use of a system embodying principles described herein, an ink usage categorization system may quickly provide a customer with a print cost quote without having to run the electronic document that includes the image to be printed through the entire print imaging pipeline. Additionally, the print cost estimation technique described herein is device independent. Thus, the business entity which will be printing the image may use any practical printing device to print the image without incurring costs far outside the quoted print cost.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for bitmap analysis for ink usage estimation performed by a physical computing system, the method comprising:
with said physical computing system, receiving an electronic document comprising an image to be printed;
with said physical computing system, analyzing a bitmap format of said image; and
with said physical computing system, using an analysis of said bitmap format of said image to determine an estimate of an amount of ink to be used to print said image.

2. The method of claim 1, in which said analyzing said bitmap format of said image comprises analyzing pixel bit values representing pixels of said image.

3. The method of claim 2, in which said pixel bit values are divided into three color plane bit values, each color plane bit value representing one color of a Red Green Blue (RGB) color scheme.

4. The method of claim 2, in which said analyzing said pixel bit values representing pixels of said image comprises determining an average pixel bit value for said pixels of said image.

5. The method of claim 2, further comprising, with said physical computing system, normalizing said pixel bit values.

6. The method of claim 1, in which said electronic document is received from a user requesting a print cost quote.

7. The method of claim 1, further comprising, with said physical computing system, providing a print cost quote based in part on said estimate of an amount of ink to be used to print said image.

8. The method of claim 1, further comprising, with said physical computing system, placing said electronic document into an ink consumption category based in part on said average pixel bit value.

9. The method of claim 8, further comprising, with said physical computing system, providing a print cost quote for said electronic document based on said ink consumption category.

10. The method of claim 1, further comprising, with said physical computing system, rasterizing said image if said image is not in a bitmap format.

11. The method of claim 1, further comprising, with said physical computing system, scaling a resolution of said image.

12. A computing device comprising:
a processor; and
a memory communicatively coupled to said processor;
in which said processor:
receives an electronic document comprising an image to be printed;
analyzes a bitmap format of said image; and
uses an analysis of said bitmap format of said image to determine an estimate of an amount of ink to be used to print said image.

13. The system of claim 12, in which to analyze said bitmap format of said image, said processor analyzes pixel bit values representing pixels of said image.

14. The method of claim 13, in which said pixel bit values are divided into three color plane bit values, each color plane bit value representing one color of a Red Green Blue (RGB) color scheme.

15. The method of claim 13, in which to analyze said pixel bit values representing pixels of said image, said processor determines an average pixel bit value for said pixels of said image.

16. The method of claim 13, in which said processor normalizes said pixel bit values.

17. The system of claim 12, in which said processor provides a print cost quote based on said estimate of an amount of ink to be used to print said image.

18. The system of claim 12, in which said processor places said electronic document into an ink consumption category based on said estimate of an amount of ink to be used to print said image and provides a print cost quote for said electronic document based on said ink consumption category.

19. The system of claim 12, in which said processor scales a resolution of said image.

20. A method for bitmap analysis for print cost estimation performed by a physical computing system, the method comprising:
with said physical computing system, receiving an electronic document comprising an image to be printed;
with said physical computing system, rasterizing said image;
with said physical computing system, determining a normalized pixel bit value for each pixel within said rasterized image, said normalized pixel bit value indicating color usage for that pixel;
with said physical computing system, determining an average normalized pixel bit value for said image; and
with said physical computing system, providing a print cost quote based in part on said average normalized pixel bit value.
